(19) United States
(12) Patent Application Publication
(10) Pub. No.: US 2017/0136503 A1
(43) Pub. Date: May 18, 2017

(54) FILM PRODUCING METHOD AND FILM WASHING DEVICE

(71) Applicant: Sumitomo Chemical Company, Limited, Tokyo (JP)

(72) Inventors: Rikuri UEJIMA, Niihama-shi (JP); Akihiko SHIN, Daegu (KR)

(21) Appl. No.: 15/348,390

(22) Filed: Nov. 10, 2016

(30) Foreign Application Priority Data
Nov. 13, 2015 (JP) 2015-223428

(51) Int. Cl. B08B 3/04; H01M 10/0525; B65H 5/06; H01M 2/14

(52) U.S. Cl. CPC B08B 3/04; H01M 2/145; H01M 10/0525; B65H 5/066; B65H 2701/1752

(57) ABSTRACT

Contamination of a washing liquid in a washing tank is suppressed at a downstream side of a path for transferring a film. A washing device includes a roller for transferring a heat-resistant separator from a washing tank to another washing tank. Two rollers contact one surface of the heat-resistant separator, and a remaining roller, between the two rollers, contacts the other surface of the heat-resistant separator. A washing liquid removed from the heat-resistant separator by the remaining roller returns to the washing tank.

This Nonprovisional application claims priority under 35 U.S.C. §119 on Patent Application No. 2015-223428 filed in Japan on Nov. 13, 2015, the entire contents of which are hereby incorporated by reference.

### TECHNICAL FIELD

The present invention relates to (i) a producing method for producing a film constituting a separator for use in a battery such as a lithium-ion secondary battery and (ii) a washing device for washing such a film.

### BACKGROUND ART

A lithium-ion secondary battery includes therein a positive electrode and a negative electrode which are separated by a separator that is in a form of film and is porous. A method for producing the separator includes a washing step of later removing an unnecessary substance from the film which has been once prepared.

A washing device for performing the washing step is disclosed in Patent Literature 1. The washing device disclosed in Patent Literature 1 washes a film by causing the film to pass through two washing tanks.

### CITATION LIST

### Patent Literature

[Patent Literature 1] Japanese Patent Application Publication Tokukai No. 2001-228594 (Publication date: Aug. 24, 2001)

### SUMMARY OF INVENTION

### Technical Problem

In the washing device disclosed in Patent Literature 1, when a film is transferred from a washing tank on an upstream side of a transferring path of the film (hereinafter referred to as washing tank A) into a washing tank on a downstream side (hereinafter referred to as washing tank B), a liquid adhered to an upper surface of the film is hardly removed. Consequently, in the washing device disclosed in Patent Literature 1, there is a possibility that a liquid filling the washing tank A enters the washing tank B.

The washing tank A and the washing tank B are each filled with a liquid for washing a film. In general, a liquid filling the washing tank A on an upstream side of a transferring path is dirtier than a liquid filling the washing tank B. Consequently, if the liquid filling the washing tank A enters the washing tank B, there arises a problem that the liquid filling the washing tank B is contaminated.

The present invention was made in view of the foregoing problem. An object of the present invention is to provide a film producing method and a film washing device each capable of subduing contamination of a washing liquid in a washing tank on a downstream side of a transferring path of a film.

### Solution to Problem

A film producing method in accordance with one aspect of the present invention includes the steps of: washing a film in a first washing tank; and transferring the film to the second washing tank by causing a first roller, a second roller, and a third roller to contact the film after the film is transferred from the first washing tank, in the step of transferring the film, the first roller and the third roller contacting one surface of the film, and the second roller contacting, between the first roller and the third roller, the other surface of the film, so that a washing liquid is removed from the film, and the washing liquid removed from the film by the second roller being returned to the first washing tank.

With the arrangement, between the washing tanks, the washing liquid adhered to both surfaces of the film are removed by the first roller and the second roller, respectively. The washing liquid removed by the second roller is returned to the first washing tank on an upstream side. This allows reducing the amount of the washing liquid in the first washing tank which liquid is brought into the second washing tank on a downstream side. This allows subduing contamination of the washing liquid in the second washing tank.

A film washing device in accordance with one aspect of the present invention includes: a first washing tank and a second washing tank each for washing a film; and a first roller, a second roller, and a third roller each for contacting the film after the film is transferred from the first washing tank and transferring the film to the second washing tank, the first roller and the third roller contacting one surface of the film, and the second roller contacting, between the first roller and the third roller, the other surface of the film, so that the second roller removes a washing liquid from the film, and the washing liquid removed from the film by the second roller being returned to the first washing tank.

### Advantageous Effects of Invention

With one aspect of the present invention, it is possible to subdue contamination of a washing liquid in a washing tank on a downstream side of a transferring path of a film.

### BRIEF DESCRIPTION OF DRAWINGS

FIG. 1 is a schematic view illustrating a cross sectional configuration of a lithium-ion secondary battery.

FIG. 2 is a schematic view illustrating a detailed configuration of the lithium-ion secondary battery illustrated in FIG. 1.

FIG. 3 is a schematic view illustrating another configuration of the lithium-ion secondary battery illustrated in FIG. 1.

FIG. 4 is a cross-sectional view illustrating a configuration of a washing device used in accordance with one Embodiment of the present invention.

FIG. 5 is a cross-sectional view of a first roller and a second roller in the washing device illustrated in FIG. 4.

FIG. 6 is a cross-sectional view illustrating an example of providing a watershoot in a case where the washing device is provided with a watershoot.

### DESCRIPTION OF EMBODIMENTS

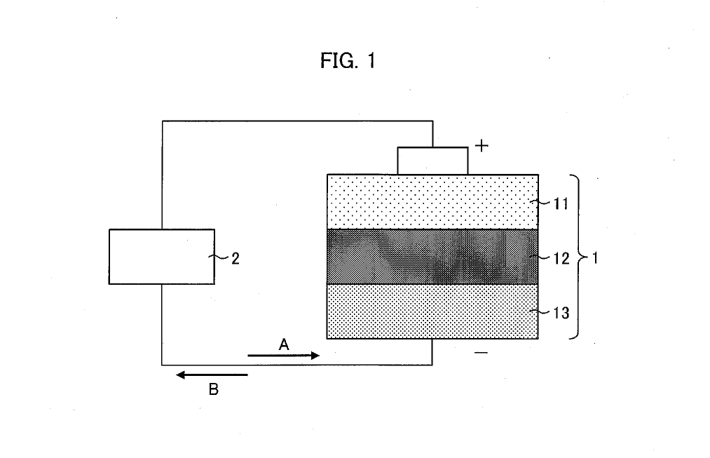

The following description will discuss embodiments of the present invention with reference to FIGS. 1 through 6.

(Lithium Ion Secondary Battery)

A nonaqueous electrolyte secondary battery, typically, a lithium-ion secondary battery has a high energy density, and therefore, currently widely used not only as batteries for use in devices such as personal computers, mobile phones, and mobile information terminals, and for use in moving bodies such as automobiles and airplanes, but also as stationary batteries contributing to stable power supply.

FIG. 1 is a diagram schematically illustrating a cross sectional configuration of a lithium-ion secondary battery 1. As illustrated in FIG. 1, the lithium-ion secondary battery 1 includes a cathode 11, a separator (film) 12, and an anode 13. Between the cathode 11 and the anode 13, an external device 2 is connected outside the lithium-ion secondary battery 1. Then, while the lithium-ion secondary battery 1 is being charged, electrons move in a direction A. On the other hand, while the lithium-ion secondary battery 1 is being discharged, electrons move in a direction B.

(Separator)

The separator 12 is provided so as to be sandwiched between the cathode 11 which is a positive electrode of the lithium-ion secondary battery 1 and the anode 13 which is a negative electrode of the lithium-ion secondary battery 1. The separator 12 is a porous film which separates the cathode 11 and the anode 13, allowing lithium ions to move between the cathode 11 and the anode 13. The separator 12 contains, for example, polyolefin such as polyethylene or polypropylene as a material.

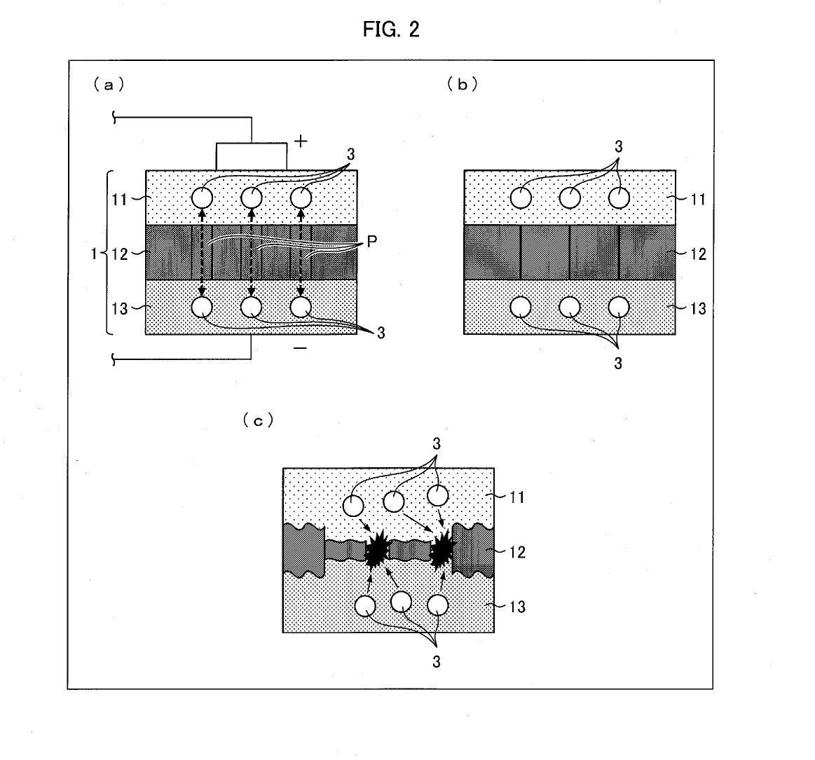

FIG. 2 provides diagrams each schematically illustrating details of the configuration of the lithium-ion secondary battery 1 illustrated in FIG. 1. (a) of FIG. 2 illustrates a normal configuration. (b) of FIG. 2 illustrates a state in which a temperature of the lithium-ion secondary battery 1 has risen. (c) of FIG. 2 illustrates a state in which a temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

However, there are, for example, cases in which the temperature of the lithium-ion secondary battery 1 rises due to excessive charging of the lithium-ion secondary battery 1, a high current caused by short-circuiting of the external device, or the like. In such cases, the separator 12 melts or softens and the pores P are blocked as illustrated in (b) of FIG. 2. As a result, the separator 12 shrinks. This stops the movement of the lithium ions 3, and consequently stops the above temperature rise.

However, in a case where a temperature of the lithium-ion secondary battery 1 sharply rises, the separator 12 suddenly shrinks. In this case, as illustrated in (c) of FIG. 2, the separator 12 may be destroyed. Then, the lithium ions 3 leak out from the separator 12 which has been destroyed. As a result, the lithium ions 3 do not stop moving. Consequently, the temperature continues rising.

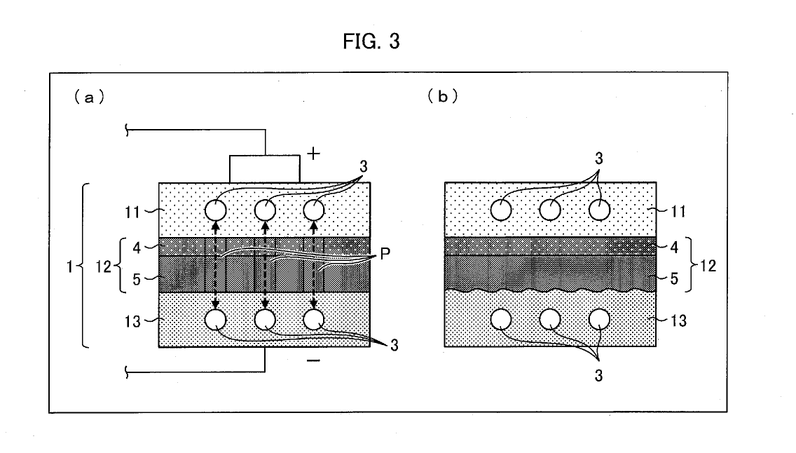

FIG. 3 provides diagrams schematically illustrating another configuration of the lithium-ion secondary battery 1 illustrated in FIG. 1. (a) of FIG. 3 illustrates a normal configuration, and (b) of FIG. 3 illustrates a state in which a temperature of the lithium-ion secondary battery 1 has sharply risen.

As illustrated in (a) of FIG. 3, the separator 12 can be a heat-resistant separator (film) that includes a porous film 5 and a heat-resistant layer 4. The heat-resistant layer 4 is laminated on a surface of the porous film 5 which surface is on a cathode 11 side. Note that the heat-resistant layer 4 can alternatively be laminated on a surface of the porous film 5 which surface is on an anode 13 side, or both surfaces of the porous film 5. Further, the heat-resistant layer 4 is provided with pores which are similar to the pores P. Normally, the lithium ions 3 move back and forth through the pores P and the pores of the heat-resistant layer 4. The heat-resistant layer 4 contains, for example, wholly aromatic polyamide (aramid resin) as a material.

As illustrated in (b) of FIG. 3, even in a case where the temperature of the lithium-ion secondary battery 1 sharply rises and as a result, the porous film 5 melts or softens, the shape of the porous film 5 is maintained because the heat-resistant layer 4 supports the porous film 5. Therefore, such a sharp temperature rise results in only melting or softening of the porous film 5 and consequent blocking of the pores P. This stops movement of the lithium ions 3 and consequently stops the above-described excessive discharging or excessive charging. In this way, the separator 12 can be prevented from being destroyed.

The separator and heat-resistant separator of the lithium ion secondary battery 1 can be produced by a method below. The following discussion assumes a case where the porous film 5 contains polyethylene as a main material. However, even in a case where the porous film 5 contains another material, similar steps can still be applied to production of the separator 12 (heat-resistant separator).

It is possible to employ a method including the steps of first forming a film by adding an inorganic filler or plasticizer to a thermoplastic resin, and then washing the film with an appropriate solvent to remove the inorganic filler or plasticizer. For example, in a case where the porous film 5 is a polyolefin separator made of a polyethylene resin containing ultrahigh molecular weight polyethylene, it is possible to produce the separator 12 by the following method.

This method includes (1) a kneading step of obtaining a polyethylene resin composition by kneading an ultrahigh molecular weight polyethylene and an inorganic filler (for example, calcium carbonate or silica) or plasticizer (for example, a low molecular weight polyolefin or liquid paraffin), (2) a rolling step of forming a film with the polyethylene resin composition, (3) a removal step of removing the inorganic filler or plasticizer from the film obtained in the step (2), and (4) a stretching step of obtaining the porous film 5 by stretching the film obtained in the step (3). The step (4) may alternatively be carried out between the steps (2) and (3).

In the removal step, many fine pores are provided in the film. The fine pores of the film stretched in the stretching step become the above-described pores P. The porous film 5 formed as a result is a polyethylene microporous film having a prescribed thickness and a prescribed air permeability (that is, a separator 12 not having a heat-resistant layer).

Note that in the kneading step, 100 parts by weight of the ultrahigh molecular weight polyethylene, 5 parts by weight to 200 parts by weight of a low-molecular weight polyolefin having a weight-average molecular weight of not more than 10000, and 100 parts by weight to 400 parts by weight of the inorganic filler can be kneaded.

Thereafter, in a coating step, the heat-resistant layer 4 is formed on a surface of the porous film 5. For example, on the porous film 5, an aramid/NMP (N-methylpyrrolidone) solution (coating solution) is applied (applying step) and solidified (solidifying step), and thereby, the heat-resistant layer 4 that is an aramid heat-resistant layer is formed. The heat-resistant layer 4 can be provided on only one surface or both surfaces of the porous film 5.

In the coating step, a polyvinylidene fluoride/dimethylacetamide solution (coating solution) may be applied (applying step) to a surface of the porous film 5 and solidified (solidifying step) to form an adhesive layer on the surface of the porous film 5. The adhesive layer can be provided on only one surface or both surfaces of the porous film 5.

In this specification, a layer, which has a function such as adhesiveness to an electrode or heat resistance to a temperature equal to or higher than a melting point of polyolefin, is referred to as “functional layer”.

A method for coating the porous film 5 with a coating solution is not specifically limited as long as uniform wet coating can be performed by the method. The method can be a conventionally well-known method such as a capillary coating method, a slit die coating method, a spray coating method, a dip coating method, a roll coating method, a screen printing method, a flexo printing method, a bar coater method, a gravure coater method, or a die coater method. The heat-resistant layer 4 has a thickness which can be controlled by adjusting a thickness of a coating wet film and/or a solid-content concentration in the coating solution.

It is possible to use a resin film, a metal belt, a drum or the like as a support with which the porous film 5 is fixed or transferred in coating.

As described above, it is possible to produce the separator 12 (heat-resistant separator) in which the heat-resistant layer 4 is laminated on the porous film 5. Thus produced separator is wound on a cylindrical core. Note that a subject to be produced by the above production method is not limited to the heat-resistant separator. The above production method does not necessarily include the coating step. In a case where the method includes no coating step, the subject to be produced is a separator having no heat-resistant layer.

(Washing Step)

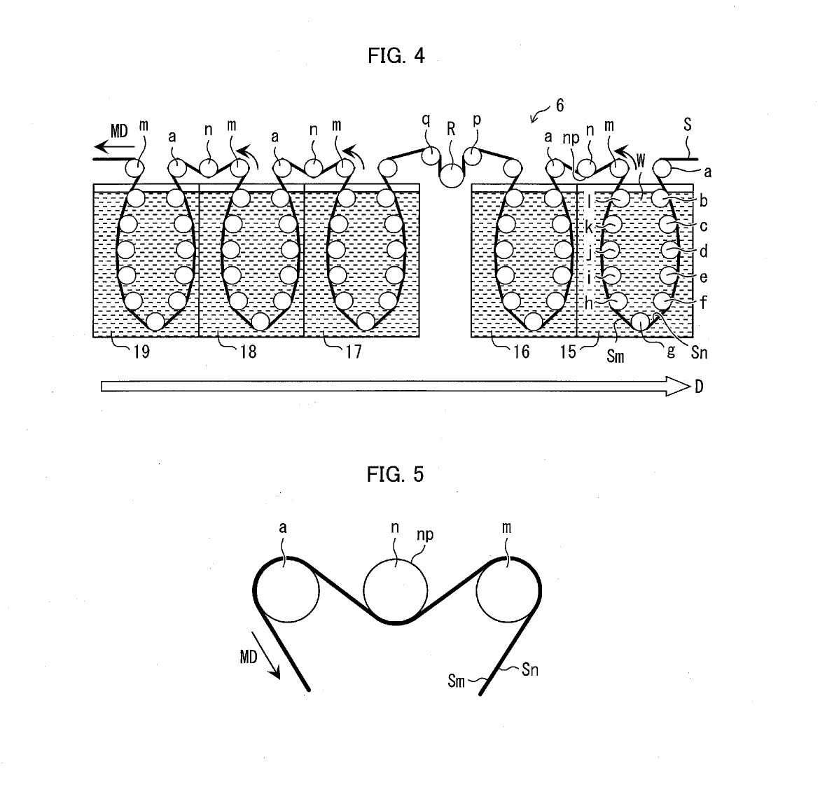

With reference to FIGS. 4 and 5, the following description will discuss a film producing method and a washing device 6 in accordance with the present embodiment.

In the following embodiment, a washing method for washing a heat-resistant separator (film producing method), which is a long and porous battery separator, is described. A heat-resistant layer of the heat-resistant separator is formed by applying an aramid/NMP (N-methylpyrrolidone) solution (coating solution) to a porous film. In this case, NMP (remove-target substance) which is a solvent sinks into pores of the porous film.

An air permeability of the heat-resistant separator in which NMP remains in the pores is lower than that of a heat-resistant separator in which no NMP remains in pores. As the air permeability is lower, movement of lithium ions of a lithium-ion secondary battery including the heat-resistant separator is further interfered with, and consequently output of the lithium-ion secondary battery decreases. Therefore, it is preferable to wash the heat-resistant separator so that NMP does not remain in the pores of the heat-resistant separator.

FIG. 4 is a cross-sectional view illustrating a configuration of the washing device 6 in accordance with the present embodiment. As illustrated in FIG. 4, the washing device 6 (film washing device) includes washing tanks 15 through 19. Each of the washing tanks 15 through 19 is filled with washing water W (washing liquid). Further, the washing device 6 includes a plurality of rollers which are rotatable for transferring a heat-resistant separator S. Among the plurality of rollers, rollers a through n are rollers for transferring the heat-resistant separator S which is to be washed in the washing tank 15.

The heat-resistant separator S which has been transferred from a step (for example, coating step) which is upstream from a washing step passes through, via the rollers a through n, the washing water W (hereinafter referred to as “water”) filling the washing tank 15. The rollers a through n (transferring roller) define a transferring path of the heat-resistant separator S in the washing tank 15. In the washing tanks 17 and 18, the heat-resistant separator S is transferred via rollers a through n similar to those in the washing tank 15. In the washing tanks 16 and 19, the heat-resistant separator S is transferred via rollers a through m similarly to the washing tank 15 except that the roller n is omitted.

The washing device 6 further includes a driving roller R and auxiliary rollers p and q. The driving roller R is a roller driven to rotate by a power such as a motor. The driving roller R is driven such that a speed of a surface of the driving roller R is the same as a speed at which the heat-resistant separator S is transferred. The driving roller R applies a force on the heat-resistant separator S in a transferring direction (MD: machine direction) between the washing tanks. The auxiliary rollers p and q define a range of a surface of the driving roller R (so-called “holding angle”) at which the heat-resistant separator S makes contact with the driving roller R. The holding angle indicates an angle formed by connecting, to the axis of a roller, endpoints of an arc of the circumference of the roller at which arc a film contacts the circumference of the roller. Although the driving roller R and the auxiliary rollers p and q can be provided in the washing water W, the driving roller R and the auxiliary rollers p and q are preferably provided between washing tanks as illustrated in FIG. 4, because it is not necessary to give a water-proof treatment to the rollers.

As described above, the driving roller R applies a driving force for transferring the heat-resistant separator S between a position of the roller a for the washing tank 15 and a position of a roller m for the washing tank 19. Here, the roller a for the washing tank 15 is a roller at a position just before bringing the heat-resistant separator S into the washing tank 15. The roller m for the washing tank 19 is a roller at a position just after taking the heat-resistant separator S out from the washing tank 19.

The driving force by the driving roller R is preferably applied to the heat-resistant separator S between a roller 1 for the washing tank 16 and a roller b for the washing tank 17. For example, the driving roller R and the auxiliary rollers p and q are preferably provided in the transferring path so as to be at positions at which the heat-resistant separator S has been transferred from the washing tank 16 on an upstream of the transferring path (from inside the water) and at which the heat-resistant separator S is not yet transferred into the washing tank 17 on a downstream of the transferring path (into the water).

The washing method of the present embodiment includes a step of transferring the heat-resistant separator S in a longitudinal direction of the heat-resistant separator S and a step of washing the heat-resistant separator S, which is being transferred, by causing the heat-resistant separator S to sequentially pass through washing waters W in the washing tanks 15 through 19. As such, the heat-resistant separator S is sequentially transferred from an upstream washing tank to a downstream washing tank. Here, unless otherwise noted, the terms “upstream” and “downstream” respectively mean an upstream side and a downstream side in a transferring direction of a separator.

After washing in the washing tanks 15 through 19 has finished, the heat-resistant separator S is transferred to a step (for example, drying step) downstream from the washing step.

In a case where the heat-resistant separator S passes through the washing water W, NMP diffuses from the pores of the heat-resistant separator S to the water. Here, a diffusion amount of NMP becomes larger as a concentration of NMP in the washing water W is lower.

The heat-resistant separator S is washed sequentially in the washing tanks 15 through 19, and therefore a concentration of NMP in washing water W is lower in a downstream washing tank than in an upstream washing tank. That is, NMP is diffused in stages, and it is therefore possible to reliably remove NMP from the pores.

As illustrated in FIG. 4, washing water W can flow in a direction D from the downstream washing tank 19 to the upstream washing tank 15 in the separator transferring direction. From this, for example, partition walls each provided between the washing tanks 15 through 19 can have heights which become lower from the downstream side to the upstream side in the separator transferring direction. In this case, in the washing method of the present embodiment, washing water W is supplied to the downstream washing tank and the washing water W in the downstream washing tank is then supplied to an upstream washing tank, and thus the washing method further includes a step of renewing a washing liquid in each of the washing tanks. From the upstream washing tank 15, part of the washing water W flows out. With the configuration, it is possible to cause an NMP concentration in washing water W in the downstream washing tank in the separator transferring direction to be lower than an NMP concentration in washing water W in the upstream washing tank, while efficiently using the washing water W.

By diffusing NMP in stages, it is possible to efficiently remove NMP, as compared with washing in only one washing tank. It is therefore possible to shorten a transferring distance of the heat-resistant separator S during washing. From this, it is possible to wash the heat-resistant separator S whose mechanical strength is lower than that of a non-porous film while inhibiting a fold and a tear.

As a width of the heat-resistant separator S becomes broader, productivity increases. Therefore, the width (i.e., a length in a direction perpendicular to MD) of the heat-resistant separator S is often set to be a width similar to that of the washing tanks 15 through 19. Moreover, the width of the washing tanks 15 through 19 is designed in accordance with the width of the heat-resistant separator S.

In a case where the width of the heat-resistant separator S is broadened and a gap between an edge of the heat-resistant separator S and the washing tanks 15 through 19 becomes smaller, washing water W in each of the washing tanks 15 through 19 is to be separated into one surface side (i.e., center side of washing tank) of the heat-resistant separator S and another surface side (i.e., both end sides of washing tank (right and left sides of washing tank in FIG. 4)) of the heat-resistant separator S.

In the washing in the washing tanks 15 through 19, the washing water W is often supplied/drained by overflow between the washing tanks 15 through 19. In this case, washing water W on the one surface side of the heat-resistant separator S may be supplied/drained, whereas washing water W on the another surface side of the heat-resistant separator S may remain.

In view of this, the washing method of the present embodiment can include a step of circulating washing water W so as to facilitate interchanging of washing waters W between the one surface side and the another surface side of the heat-resistant separator S in at least one of the washing tanks 15 through 19. In this case, the washing device 6 can further include a circulating device which is provided in the at least one of the washing tanks 15 through 19 and has an inlet and an outlet for washing water W. This makes it possible to further uniformize an NMP concentration in washing water W in one washing tank, and it is therefore possible to facilitate efficient removal of NMP.

The washing water W is not limited to water, provided that the washing water W is a washing liquid which can remove NMP from the heat-resistant separator S. Moreover, the washing water W can contain a cleaning agent such as a surfactant, an acid (e.g., hydrochloric acid), or a base. A temperature of the washing water W is preferably 120° C. or lower. With this temperature condition, heat shrinkage of the heat-resistant separator S is less likely to occur. The temperature of the washing water W is more preferably 20° C. or higher and 100° C. or lower.

The above washing method for washing the heat-resistant separator S is applicable to a washing method for washing a separator (e.g. polyolefin separator) having no heat-resistant layer.

The separator is formed by, for example, stretching a film-shaped polyolefin resin composition which has been obtained by kneading high molecular weight polyolefin such as ultrahigh molecular weight polyethylene and an inorganic filler or a plasticizer. Further, the remove-target substance such as the inorganic filler or the plasticizer is washed, and thus pores of the separator are formed.

An air permeability of a separator in which the remove-target substance has not been washed and remains in pores is lower than an air permeability of a separator in which the remove-target substance does not remain in pores. As the air permeability is lower, movement of lithium ions of a lithium-ion secondary battery including a separator is further interfered with, and consequently output of the lithium-ion secondary battery decreases. Therefore, it is preferable to wash the separator so that the remove-target substance does not remain in the pores of the separator.

A washing liquid for washing a separator containing an inorganic filler is not limited, provided that the washing liquid can remove the inorganic filler from the separator. The washing liquid is preferably an aqueous solution containing an acid or a base.

A washing liquid for washing a separator containing a plasticizer is not limited, provided that the washing liquid can remove the plasticizer from the separator. The washing liquid is preferably an organic solvent such as dichloromethane.

The outline of the above is as follows: that is, the washing method for washing a film-shaped polyolefin resin composition (film) includes the steps of (i) transferring a film, which is long and is an intermediate product of the separator, in a longitudinal direction of the film and (ii) washing the film by causing the film, which is being transferred, to sequentially pass through washing liquids in the respective washing tanks 15 through 19.

As such, in FIG. 4, the heat-resistant separator S can serve as a film which is an intermediate product of a separator. Moreover, the washing water W can be an aqueous solution which contains an acid or a base.

The method for producing a polyolefin separator can be construed as including (i) a forming step of forming a film which is long, is an intermediate product of a long and porous separator, and contains polyolefin as a main component and (ii) the steps of the above film washing method which steps are carried out after the forming step.

The present invention encompasses a method for producing a heat-resistant separator S, which is a laminated separator, with use of the washing method for washing the heat-resistant separator S. Here, the heat-resistant separator S is a laminated separator including a porous film 5 (base material) and a heat-resistant layer 4 (functional layer) which is laminated on the porous film 5, as illustrated in FIG. 3. This producing method can be construed as including a forming step of forming a long and porous heat-resistant separator S and the steps in the above described separator washing method which steps are carried out after the forming step.

In order to laminate the heat-resistant layer 4, the “forming step” includes an applying step of applying, to the porous film 5, NMP (liquid substance) containing aramid resin (substance) for constituting the heat-resistant layer 4 and a solidifying step of solidifying the aramid resin after the applying step.

The “steps” mean the steps of (i) transferring the heat-resistant separator S in the longitudinal direction thereof and (ii) washing the heat-resistant separator S by causing the heat-resistant separator S, which is being transferred, to sequentially pass through washing waters W in the respective washing tanks 15 through 19.

From this, it is possible to produce the laminated separator which hardly contains NMP and in which a fold and a tear are inhibited. Note that the heat-resistant layer can be the early described adhesive layer.

(M-Shaped Path)

The following description will discuss the roller m, the roller n, and the roller a each included in the washing device 6 in more details. A description will be made here as to the roller m, the roller n, and the roller a provided between the washing tank 15 and the washing tank 16. Note that the same description is applicable to the roller m, the roller n, and the roller a provided between the washing tank 17 and the washing tank 19.

FIG. 5 is a cross sectional view illustrating a set of the roller m, the roller n, and the roller a in the washing device illustrated in FIG. 4. The set of the roller m (first roller), the roller n (second roller), and the roller a (third roller) are provided in the transferring path so as to be between the washing tank 15 on the upstream of the transferring path (first washing tank) and the washing tank 16 on the downstream of the transferring path (second washing tank). The roller n is provided between the roller m and the roller a. When seen from above, the roller m and the roller n are within the range of the washing tank 15, and the roller a is within the range of the washing tank 16. The rollers m, n, and a may be each a driving roller driven by a force to rotate, or may be a driven roller which is rotated by a frictional force derived from friction with the heat-resistant separator S. Here, respective speeds of surfaces of the rollers m, n, and a are equal to a transferring speed of the heat-resistant separator S.

The heat-resistant separator S transferred from the washing tank 15 (from inside the water) contacts the roller m, the roller n, and the roller a in this order, and is transferred into the washing tank 16 (into the water). The roller m, the roller n, and the roller a transfer the heat-resistant separator S between the washing tanks (transferring step).

The rollers m and a contact one surface Sm of the heat-resistant separator S. Between the rollers m and a, the roller n contacts the other surface Sn of the heat-resistant separator S. The rollers m and a support one side (lower side) of the heat-resistant separator S and the roller n presses the heat-resistant separator S from the other side (upper side) of the heat-resistant separator S. A direction of transferring the heat-resistant separator S changes at the roller n from a downward direction to an upward direction. The heat-resistant separator S passes through an M-shaped transferring path when seen from an axis direction of the roller m. When the roller m contacts the heat-resistant separator S, the washing water W adhered to the surface Sm side of the heat-resistant separator S is removed from the heat-resistant separator S. When the roller n contacts the heat-resistant separator S, the washing water W adhered to the surface Sn side of the heat-resistant separator S is removed from the heat-resistant separator S. The washing water W adhered to the heat-resistant separator S transferred from the washing tank 15 has similar degree of contamination (similar concentration of a remove-target substance) to the washing water W filling the washing tank 15.

The washing water W removed from the surface Sm by the roller m returns to the washing tank 15 on the upstream. Similarly, the washing water W removed from the surface Sn by the roller n returns to the washing tank 15 on the upper stream. For example, the washing water W moves on the surface Sn which is on the upper side of the heat-resistant separator S so as to be along the roller n in a width direction of the heat-resistant separator S, and overbrims an end portion of the heat-resistant separator S.

In a case where the rollers m and n are within the range of the washing tank 15 when seen from the above, the washing water W falling from the rollers m and n returns to the washing tank 15. Alternatively, in a case where at least lower ends of the rollers m and n are within the range of the washing tank 15, the washing water W falling from the rollers m and n returns to the washing tank 15. Alternatively, a watershoot may be provided below each of the rollers m and n so that the removed washing water W can return to the washing tank 15 via the watershoot.

Thus, the moisture adhered to both surfaces of the heat-resistant separator S transferred from the washing tank 15 is removed from the heat-resistant separator S and falls down to the washing tank 15. This allows reducing an amount of the washing water W which has filled the washing tank 15 (dirtier than the washing water W filling the washing tanks 16-19) and which is brought into the washing tanks 16-19 on the downstream of the washing tank 15. This allows preventing contamination (increase in concentration of a remove-target substance) of the washing water W filling the washing tanks 16-19. Furthermore, the liquid with high concentration of a remove-target substance, adhered to the surface of the heat-resistant separator S, is removed from the surface of the heat-resistant separator S between the washing tanks, so that in the washing tank on the downstream, the remove-target substance can be efficiently dispersed from the heat-resistant separator S.

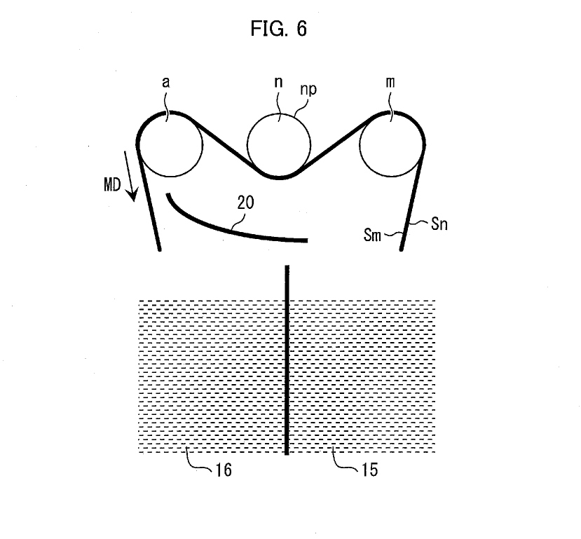

FIG. 6 is a cross sectional view illustrating an example of disposing a watershoot in a case where the washing device is provided with the watershoot. As illustrated in FIG. 6, a watershoot 20 may be provided between the washing tank 15 and the washing tank 16. Here, when seen from above, respective lowest points of the rollers n and a are included in the range of the watershoot 20. In a case where a watershoot is provided below the roller m, n, or a, the roller is not required to be within the range of the washing tank 15. Here, the roller n is positioned between the washing tank 15 and the washing tank 16. The washing water W having fallen from the roller m returns to washing tank 15. The washing water fallen from the rollers n and a is received by the watershoot 20 and returns to the washing tank 15 via the watershoot 20.

It is preferable that when seen from a transverse direction (TD), positions of respective rotation axes of the three rollers m, n, and a are on a straight line. In other words, it is preferable that respective rotation axes of the three rollers m, n, and a are on a single plane. Furthermore, it is preferable that a holding angle of the roller n is less than 180 degrees. The holding angle indicates an angle formed by connecting, to the axis of a roller, endpoints of an arc of the roller at which arc the heat-resistant separator S contacts the roller. That is, a direction of transferring the heat-resistant separator S changes at the roller by an angle corresponding to the holding angle of the roller.

(Rotation of Roller)

A speed of a surface np of the roller n may be different from a transferring speed of the heat-resistant separator S. That is, the surface np (curved surface) of the roller n slides with respect to the heat-resistant separator S. In this case, the roller n may be a driving roller driven to rotate at a predetermined speed or may be a driven roller. In a case where the surface np of the roller n slides with respect to the heat-resistant separator S, it is preferable that the surface np of the roller n (a part of the roller n which part contacts the heat-resistant separator S) is made of resin. In a case where the surface np of the roller n is made of resin, it is possible to reduce a frictional force between the roller n and the heat-resistant separator S, thereby preventing abrasion and breakage of the heat-resistant separator S.

In a case where the roller n is a driven roller, setting a frictional force between the roller n and the axis thereof to be large to some extent allows the surface np of the roller n to be dragged by the heat-resistant separator S.

In the case where the roller n is a driving roller, a direction in which the surface np of the roller n moves rotationally may be identical with a direction in which the heat-resistant separator S is transferred or may be different from the direction in which the heat-resistant separator S is transferred. In a case where the direction in which the surface np of the roller n moves rotationally is different from the direction in which the heat-resistant separator S is transferred, sliding between the roller n and the heat-resistant separator S allows more efficiently removing the washing water W from the surface Sn of the heat-resistant separator S.

Alternatively, the roller n may be fixed so as not to rotate. The surface of the roller n may be made of a metal.

The rollers m and a may be configured identically with the roller n.

(Shape of Surface of Roller)

Furthermore, the surface np of the roller n may have concavity and convexity. For example, as the concavity and convexity, the surface np of the roller n may have a helical groove, a curved groove, or a straight groove. It is preferable that the groove on the surface np of the roller n extends beyond ends of the heat-resistant separator S in a width direction of the heat-resistant separator S. This allows washing water removed between the roller n and the heat-resistant separator S to flow through the groove and be discharged outwardly of the heat-resistant separator S in the width direction of the heat-resistant separator S. It is preferable that the helical groove is formed in such a manner that a portion of the helical groove which portion faces the heat-resistant separator S shifts outwardly in the width direction of the heat-resistant separator S with time. The straight groove may be formed to be parallel to the axis of the roller n.

Similarly with the roller n, the rollers m and a may have concavity and convexity (groove) on surfaces thereof. A watershoot may be provided below the roller a so that the washing water W removed by the roller a returns to the washing tank 15.

The washing device 6 may wash, instead of the heat-resistant separator S, a separator having no functional layer or various films such as a plastic film having no pores.

[Additional Matters]

Furthermore, the film producing method may be arranged such that a speed of a surface of the second roller is different from a speed of transferring the film.

With the arrangement, the second roller slides with respect to the film. This allows more efficiently removing a washing liquid adhered to the film.

Furthermore, the film producing method may be arranged such that the second roller is driven to rotate.

With the arrangement, by setting the speed of the surface of the second roller to be not less than the speed of transferring the film, it is possible to pull the film toward a transferring direction. The film passing through a liquid suffers from resistance due to viscosity of the liquid. By driving the second roller between the washing tanks, it is possible to reduce a tension of the film on an upstream side of the second roller, so that breakage of the film is prevented. Alternatively, by setting the speed of the surface of the second roller to be less than the speed of transferring the film, it is possible to more efficiently remove a washing liquid adhered to the film.

Furthermore, the film producing method may be arranged such that the second roller has concavity and convexity on a surface thereof.

With the arrangement, the washing liquid removed from the film by the concavity and convexity can be efficiently discharged to the outside of the film.

Furthermore, the film producing method may be arranged such that the surface of the second roller may have a helical groove, a curved groove, or a straight groove.

With the arrangement, it is possible to discharge, via the groove, the washing liquid having been removed from the film.

Furthermore, the film producing method may be arranged such that the helical groove, the curved groove, or the straight groove on the second roller extends beyond ends of the film in a width direction of the film.

With the arrangement, it is possible to discharge, outwardly in a width direction of the film via the groove, the washing liquid having been removed from the film.

Furthermore, the film producing method may be arranged such that the surface of the second roller slides with respect to the film, and the surface is made of a resin.

With the arrangement, it is possible to prevent abrasion or breakage of the film.

Furthermore, the film washing device may be arranged such that a speed of a surface of the second roller is different from a speed of transferring the film.

Furthermore, the film washing device may be arranged such that the second roller is driven to rotate.

Furthermore, the film washing device may be arranged such that the second roller has concavity and convexity on a surface thereof.

Furthermore, the film washing device may be arranged such that the surface of the second roller may have a helical groove, a curved groove, or a straight groove.

Furthermore, the film washing device may be arranged such that the helical groove, the curved groove, or the straight groove on the second roller extends beyond ends of the film in a width direction of the film.

Furthermore, the film washing device may be arranged such that the surface of the second roller slides with respect to the film, and the surface is made of a resin.

The present invention is not limited to the embodiments, but can be altered by a skilled person in the art within the scope of the claims. An embodiment derived from a proper combination of technical means each disclosed in a different embodiment is also encompassed in the technical scope of the present invention.

### REFERENCE SIGNS LIST

6 Washing device (film washing device)
12 Separator (film)
15, 16 Washing tank (first washing tank, second washing tank)
S Heat-resistant separator (film)
W Washing water (washing liquid)
m roller (first roller)
n roller (second roller)
a roller (third roller)

1. A film producing method, comprising the steps of:
washing a film in a first washing tank; and
transferring the film to the second washing tank by causing a first roller, a second roller, and a third roller to contact the film after the film is transferred from the first washing tank,
in the step of transferring the film,
the first roller and the third roller contacting one surface of the film, and the second roller contacting, between the first roller and the third roller, the other surface of the film, so that a washing liquid is removed from the film, and
the washing liquid removed from the film by the second roller being returned to the first washing tank.

2. The film producing method as set forth in claim 1, wherein a speed of a surface of the second roller is different from a speed of transferring the film.

3. The film producing method as set forth in claim 1, wherein the second roller is driven to rotate.

4. The film producing method as set forth in claim 1, wherein the second roller has concavity and convexity on a surface thereof.

5. The film producing method as set forth in claim 4, wherein the surface of the second roller has a helical groove, a curved groove, or a straight groove.

6. The film producing method as set forth in claim 5, wherein the helical groove, the curved groove, or the straight groove on the second roller extends beyond ends of the film in a width direction of the film.

7. The film producing method as set forth in claim 2, wherein the surface of the second roller slides with respect to the film, and the surface is made of a resin.

8. A film washing device, comprising:
a first washing tank and a second washing tank each for washing a film; and
a first roller, a second roller, and a third roller each for contacting the film after the film is transferred from the first washing tank and transferring the film to the second washing tank,
the first roller and the third roller contacting one surface of the film, and the second roller contacting, between the first roller and the third roller, the other surface of the film, so that the second roller removes a washing liquid from the film, and
the washing liquid removed from the film by the second roller being returned to the first washing tank.

9. The film washing device as set forth in claim 8, wherein a speed of a surface of the second roller is different from a speed of transferring the film.

10. The film washing device as set forth in claim 8, wherein the second roller is driven to rotate.

11. The film washing device as set forth in claim 8, wherein the second roller has concavity and convexity on a surface thereof.

12. The film washing device as set forth in claim 11, wherein the surface of the second roller has a helical groove, a curved groove, or a straight groove.

13. The film washing device as set forth in claim 12, wherein the helical groove, the curved groove, or the straight groove on the second roller extends beyond ends of the film in a width direction of the film.

14. The film washing device as set forth in claim 9, wherein the surface of the second roller slides with respect to the film, and the surface is made of a resin.
